(19) United States
(12) Patent Application Publication
(10) Pub. No.: US 2015/0035988 A1
(43) Pub. Date: Feb. 5, 2015

(54) VIDEO IMAGING SYSTEM INCLUDING A PLURALITY OF CAMERAS AND A PLURALITY OF BEAMSPLITTERS

(71) Applicant: Ultraview, Carlstadt, NJ (US)

(72) Inventors: Jeremy C. Traub, Pasadena, CA (US); Jeffrey S. Cohen, Saddle River, NJ (US)

(21) Appl. No.: 14/449,956

(22) Filed: Aug. 1, 2014

Related U.S. Application Data
(60) Provisional application No. 61/861,748, filed on Aug. 2, 2013.

(51) Int. Cl. H04N 7/18; H04N 13/02; H04N 7/015

(52) U.S. Cl. CPC H04N 7/181; H04N 7/015; H04N 13/0242
USPC 348/159

(57) ABSTRACT

An imaging system includes a plurality of cameras and a plurality of beamsplitters, all of which are fixedly attached to a housing. Each camera can have an optical axis that extends from the camera, transmits or reflects from at least one beamsplitter, and extends toward a scene. The optical axes from the cameras can all be angularly displaced from each other, so that the cameras can collect light from different portions of the scene. The cameras can have nodal points that are all coincident, in both lateral and longitudinal directions, when the optical paths are unfolded. The portions of the scene collected by the cameras can be directly adjacent to one another or can overlap slightly. The imaging system includes software that can stitch together the portions of the scene. The imaging system can produce video images that have higher resolutions (e.g., more pixels) than the individual cameras.

### CROSS-REFERENCE TO RELATED APPLICATION

This application claims the benefit of U.S. Provisional Application No. 61/861,748, filed Aug. 2, 2013, which is incorporated by reference herein in its entirety.

### TECHNICAL FIELD

The present invention relates to a video imaging system that includes multiple cameras and multiple beamsplitters.

### BACKGROUND

There is increasing demand for video content having extremely high resolutions (e.g., number of pixels). For example, the number of pixels in a present-day digital sign can be in the tens of millions, or even the hundreds of millions. Providing video content at such high resolution can be challenging. In particular, it is difficult to generate live-action video at these high resolutions, because the number of pixels in a high-resolution display can exceed the number of pixels in a digital camera.

### SUMMARY

An imaging system includes a first plurality of cameras and a second plurality of beamsplitters, all of which are fixedly attached to a housing. In some examples, the imaging system can include three cameras and two beamsplitters mounted in the housing. In some examples, the imaging system can include more than three cameras and two or more beamsplitters arranged within the housing. Each camera has an optical axis that extends from the camera, transmits or reflects from at least one beamsplitter, and extends toward a scene. In some examples, the optical axes from the cameras are all angularly displaced from each other, so that the cameras can collect light from different portions of the scene. In some examples, the cameras have entrance pupils that are all coincident, in both lateral and longitudinal directions, when the optical paths are unfolded. In other examples, the cameras have nodal points that are all coincident, in both lateral and longitudinal directions, when the optical paths are unfolded. The portions of the scene collected by the cameras can be directly adjacent to one another or can overlap slightly. The imaging system includes software that can stitch together the portions of the scene. The software can synchronize image capture from the various cameras. For example, the software can assemble synchronized footage from multiple cameras into a single image. In some examples, the software can perform the stitching in real time, and can output a single video stream (or file) that includes the stitched images. The system can produce video images that have higher resolutions (e.g., more pixels) than the individual cameras.

### BRIEF DESCRIPTION OF THE DRAWINGS

FIG. 1 is a schematic side view of an example video imaging system.

FIG. 2 is a perspective view of the video imaging system of FIG. 1.

FIG. 3 is a schematic side view of the video imaging system of FIGS. 1 and 2.

FIG. 4 is a schematic drawing of unfolded optical paths of two cameras in the video imaging system of FIGS. 1 and 2, with coincident entrance pupils.

FIG. 5 is a schematic drawing of unfolded optical paths of two cameras in the video imaging system of FIGS. 1 and 2, with coincident nodal points.

### DETAILED DESCRIPTION

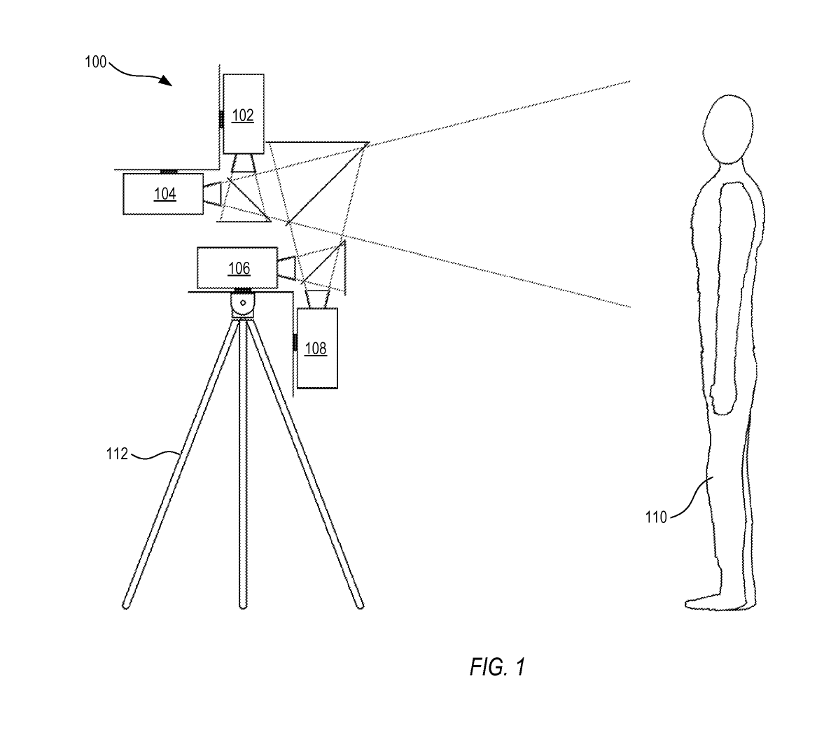

FIG. 1 is a schematic side view of an example video imaging system 100. The video imaging system 100 can be used for capturing high-end video, with relatively high resolutions (e.g., number of pixels per frame). The video imaging system 100 includes four cameras 102, 104, 106, 108, which are synchronized to one another or to an external clock signal. The cameras 102, 104, 106, 108 can be fixedly mounted to a housing (not shown). The housing can be mounted on a tripod 112, can be handheld, or can be mounted on a suitable rig. In some examples, each camera 102, 104, 106, 108 includes its own lens or combination of lenses; in other examples, the cameras 102, 104, 106, 108 can all share one or more common lens elements.

The video imaging system 100 receives light from a scene 110. The scene 110 is represented schematically by a human outline in FIG. 1, although any suitable scene may be used. The scene can be a fixed distance away from the video imaging system 100, where the fixed distance can extend from a few inches to an infinite distance.

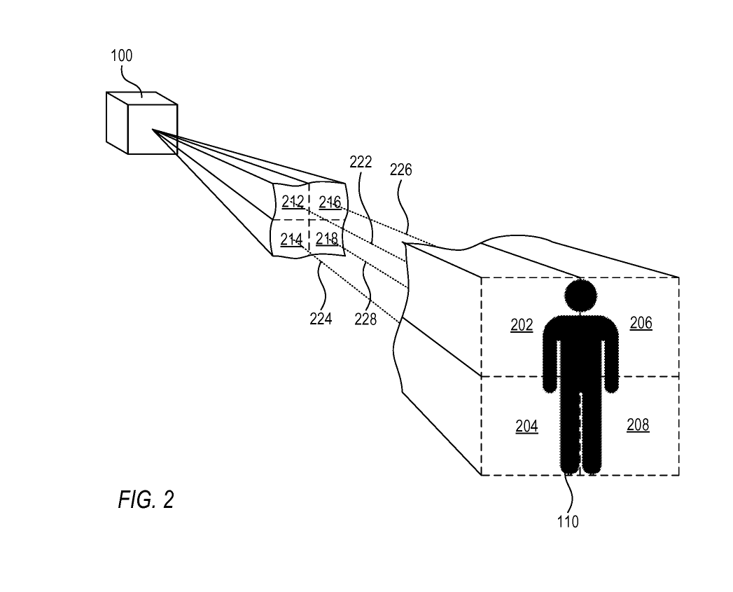

FIG. 2 is a perspective view of the video imaging system 100 of FIG. 1. Each of the cameras 102, 104, 106, 108 in the video imaging system 100 captures a respective portion 202, 204, 206, 208 of the scene 110. The captured portions 202, 204, 206, 208 can be directly adjacent to one another, or can overlap slightly, so that the captured portions 202, 204, 206, 208 can be stitched together to form a full image of the scene 110. The stitching can be performed in software, either in real time or in post-processing at a later time, after the video footage has been saved.

Each camera 102, 104, 106, 108 receives a cone of light from the scene 110. Typically, the sensors in the cameras are rectangular, so that the cones have rectangular edges defined by the sensor edges. Although the light propagates from the scene 110 to the video imaging system 100, it may be helpful to envision the cones as extending from the video imaging system 100 to the scene 110. FIG. 2 shows cones 212, 214, 216, 218 emerging from respective cameras 102, 104, 106, 108. Each cone 212, 214, 216, 218 has a central axis 222, 224, 226, 228 at its center. The cones extend from entrance pupils at the respective cameras to respective portions 202, 204, 206, 208 of the scene 110.

In the example of FIG. 2, the portions 202, 204, 206, 208 are arranged as quadrants of the full scene 110. In other examples, the portions can be arranged linearly, in a staggered formation, or irregularly. Each portion can have an aspect ratio corresponding to that of a sensor in the respective camera.

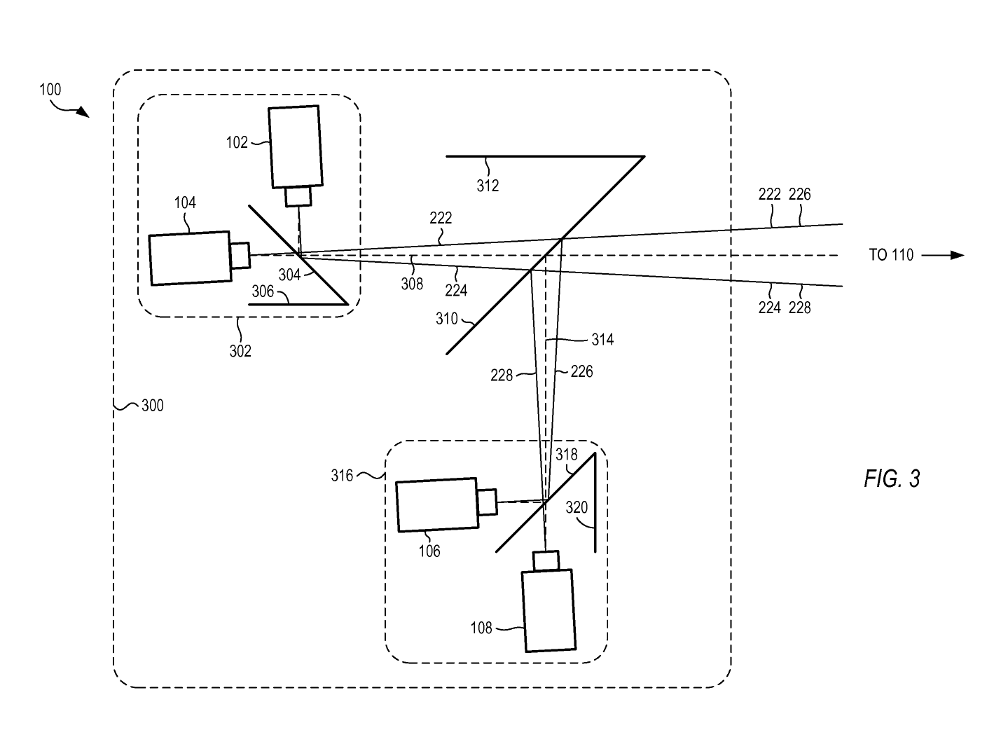

FIG. 3 is another side view of the video imaging system 100, showing the central axes 222, 224, 226, 228 in detail at the video imaging system 100. The central axes extend from the entrance pupils of respective cameras 102, 104, 106, 108, through various transmissions and reflections from beamsplitters 304, 310, 318, toward different portions of a scene 110. An example of a suitable beamsplitter is a partially silvered mirror, oriented at 45 degrees to an incident beam, which transmits about 50% of the incident light and reflects about 50% of the incident beam. The beamsplitters are not dichroic beamsplitters, and have roughly the same reflectivity across the full visible spectrum. The beamsplitters can be mounted with suitable light baffles 302, 312, 320 that block one of the transmitted paths through the beamsplitter.

Central axis 222 originates at the center of the entrance pupil of camera 102, reflects off beamsplitter 304, transmits through beamsplitter 310, and exits housing 300. Central axis 224 originates at the center of the entrance pupil of camera 104, transmits through beamsplitter 304, transmits through beamsplitter 310, and exits housing 300. Central axis 226 originates at the center of the entrance pupil of camera 106, reflects off beamsplitter 318, reflects off beamsplitter 310, and exits housing 300. Central axis 228 originates at the center of the entrance pupil of camera 108, transmits through beamsplitter 318, reflects off beamsplitter 310, and exits housing 300.

After exiting the housing 300, the central axes 222, 224, 226, 228 are all directed toward a common scene 110, but are angularly separated from one another. In FIG. 3, central axes 226 and 228 extend into the plane of the page, and central axes 222 and 224 extend out of the plane of the page.

The cameras 104, 106, 108, 106 in FIG. 3 are angled slightly away from orthogonal orientations, so that the central axes 222, 224, 226, 228 are all angled slightly away from orthogonal axes 308, 314.

In some examples, the cameras are mounted in pairs. For instance, cameras 102, 104 are mounted on subhousing 302, cameras 106, 108 are mounted on subhousing 316, and subhousings 302, 316 are mounted within housing 300.

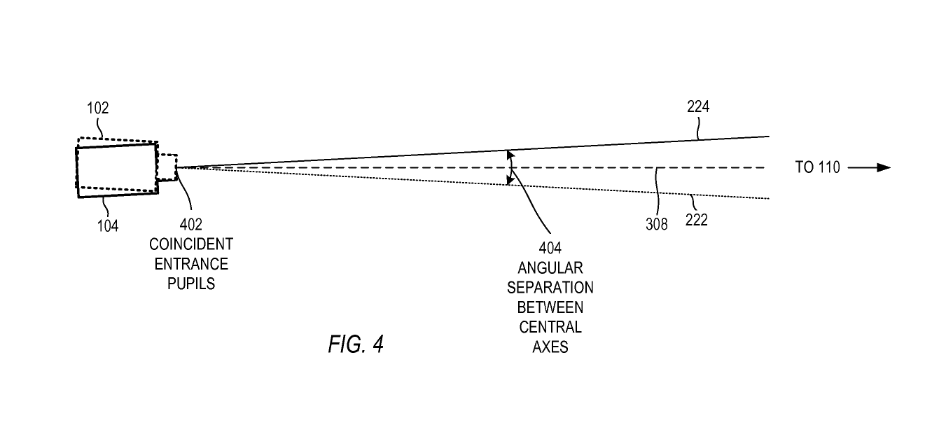

FIG. 4 shows cameras 102, 104 and respective central axes 222, 224, when the optical paths are unfolded. The cameras 102, 104 are oriented so that their respective entrance pupils 402 are coincident, in both lateral and longitudinal directions, when the optical paths are unfolded. The cameras 102, 104 are oriented to have an angular separation 404 between their respective central axes 222, 224.

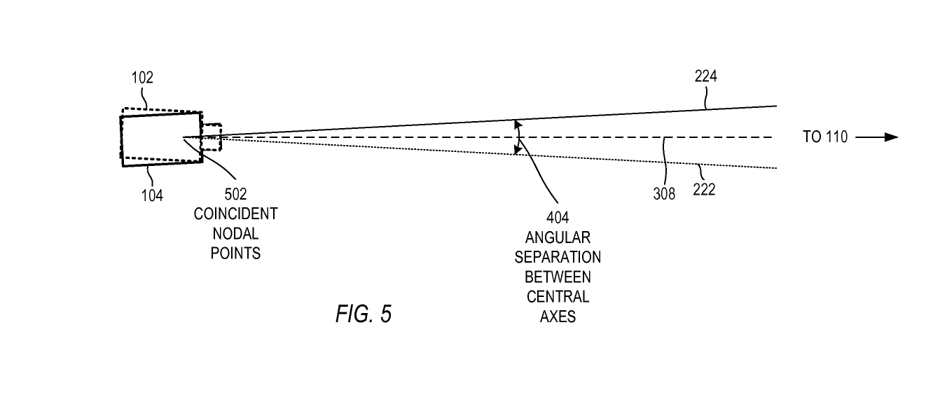

As an alternative, FIG. 5 shows cameras 102, 104 and respective central axes 222, 224, when the optical paths are unfolded. The cameras 102, 104 are oriented so that their respective nodal points 502 are coincident, in both lateral and longitudinal directions, when the optical paths are unfolded. The nodal point of a camera is usually located within the body of the camera, rather than at a front face of the camera. In some cases, the nodal point is about one-third of the length back from the front end of the camera. The cameras 102, 104 are oriented to have an angular separation 404 between their respective central axes 222, 224.

In the examples of FIGS. 1 and 3, the beamsplitters are oriented so that the reflected beams remain generally in the plane of the page of the figures. For instance, light traveling from the scene 110 toward beamsplitter 310, moving right-to-left in FIG. 3, has a 50% reflection from beamsplitter 310 that travels downward in FIG. 3. There are other suitable orientations for the beamsplitters. For instance, one or more of the beamsplitters can direct the reflected portions into the page or out of the page in FIG. 3. As an example, beamsplitter 310 can be rotated 90 degrees, so that light traveling from the scene 110 toward beamsplitter 310, moving right-to-left in FIG. 3, has a 50% reflection from beamsplitter 310 that travels out of the page, toward the viewer, in FIG. 3. Beamsplitters 304, 318 can also have orientations that direct reflected portions out of the plane of the page in FIG. 3. As a further alternative, one or more of the beamsplitters can be rotated at any suitable azimuthal angle, with respect to the orthogonal axis 308, including 45 degrees, 90 degrees, 135 degrees, 180 degrees, 225 degrees, 270 degrees, or 315 degrees.

In the examples of FIGS. 1-3, there are four cameras. Alternatively, there may be three cameras, five cameras, six cameras, seven cameras, eight cameras, or more than eight cameras. For example, a system having four cameras and three beamsplitters can increase the pixel resolution by a factor of four, with two-stop light loss. As another example, a system having eight cameras and seven beamsplitters can increase the pixel resolution by a factor of eight, with three-stop light loss. As still another example, a system having 16 cameras and 15 beamsplitters can increase the pixel resolution by a factor of 16, with four-stop light loss.

In each of these configurations, each camera has an entrance pupil, or a nodal point, coincident with those of the other cameras, when the optical paths are unfolded. Similarly, for each of these alternative configurations, each camera can have a central axis that is angularly separated from those of the other cameras, when the optical paths are unfolded.

An example method of operation is as follows. First, a user connects to each of the plurality of cameras in the system. Second, the system synchronizes each of the plurality of cameras to a common clock signal, to control image capture from each camera of the plurality of cameras. Third, the system receives synchronized images from the plurality of cameras. Fourth, the system stitches the synchronized images received from the plurality of cameras into a single high-resolution image. Fifth, the system outputs, or saves, the single high-resolution image. The system performs the third, fourth, and fifth operations at a frame rate of the cameras. Other suitable methods of operation can also be used.

In some examples, the cameras can be used for high-definition video recording, such as for cinema. In some of these examples, the cameras can be mounted in pairs on a rig that is designed to hold cameras for stereoscopic video imaging. Such rigs are commercially available and are well-known in the field of video imaging. The rigs are well-suited to affix the cameras and beamsplitter in selectable orientations with respect to one another, then affix all the optical elements, in the selected orientations, onto a tripod or other suitable mount.

As an example, FIG. 8 of U.S. Pat. No. 8,478,122 shows a schematic drawing of two cameras and a beamsplitter, as mounted on a known rig. The cameras and beamsplitter in FIG. 8 of U.S. Pat. No. 8,478,122 are arranged to capture video for a stereoscopic, or three-dimensional, display. There are important differences between the present device and the stereoscopic arrangement of FIG. 8 of U.S. Pat. No. 8,478,122.

As a first difference, the present device uses three or more cameras. In contrast, only two cameras are used to generate stereoscopic video, with one camera capturing video to be used for a left eye, and the other camera capturing video to be used for a right eye. There is no motivation to add additional cameras to a stereoscopic device, because such additional cameras would not provide any useful additional three-dimensional information about the scene.

As a second difference, the present device has camera entrance pupils, or nodal points, that are all coincident (e.g., have zero lateral separation among them). In contrast, the two cameras in a stereoscopic device are positioned to have their entrance pupils, or nodal points, laterally separated by about 65 millimeters. This distance corresponds to the center-to-center separation between the eyes of a typical human, and is known equivalently as pupillary distance, interpupillary distance, or intraocular distance. There is no motivation to modify a stereoscopic device to have an interpupillary distance of zero, because to do so would completely remove any stereoscopic effects from the video signals. In essence, such a modification would be equivalent to trying to view a stereoscopic image with only one eye. If modified to have an interpupillary distance of zero, the stereoscopic device would fail to operate as intended.

As a third difference, the present device has camera central axes that are all angularly offset from one another. These angularly offset central axes ensure that the cameras capture different portions of the same scene, which are stitched together in software to form a single high-resolution image of the scene. In contrast, the two cameras in a stereoscopic device are all oriented to have parallel central axes. This parallelism ensures that the left and right eyes are observing the same portions of a scene. There is no motivation to introduce an angular offset between the central axes of a stereoscopic device, because to do so would mean that the left and right eyes would be viewing different portions of a scene, and not the same portion. If modified to have angularly offset central axes, the stereoscopic device would fail to operate as intended.

Another example of an application for the present device is for medical imaging, such as for an endoscope. The cameras and mechanical mounts for medical imaging can be relatively small, compared with cinematic video system, so that the assembled device can be a scaled-down version of the cinematic video system.

In some examples, it can be preferable to use multiple lenses to image respective portions of a scene, rather than using a single lens to image the entire scene. The multiple lenses can each have a smaller field of view than a comparable lens that images the entire scene, and can therefore deliver better resolution within the smaller fields of view than the comparable lens.

In the examples described above, the cameras have central axes that are angularly separated from one another. In other examples, it can be beneficial to position the cameras so that the central axes area all parallel. For instance, in instances requiring a high dynamic range or a high frame rate, the cameras can be positioned so that their nodal points align and their central axes can be parallel, when the optical system is unfolded. For these examples, each camera captures the same portion of the scene, from the same angle. For a high dynamic range, the cameras can be configured to have different dynamic ranges. For high frame rate, the cameras can have their signals interleaved. Other applications are also possible.

The above description is intended to be illustrative, and not restrictive. For example, the above-described examples (or one or more aspects thereof) can be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A video imaging system, comprising:
a housing;
at least three cameras fixedly attached to the housing;
at least two beamsplitters fixedly attached to the housing, the plurality of beamsplitters forming folded optical paths between the at least three cameras and respective portions of a scene;
wherein the cameras have respective nodal points that are all coincident when the optical paths are unfolded;
wherein the cameras have respective central axis that all extend in different directions when the optical paths are unfolded.

2. The video imaging system of claim 1, wherein the respective portions of the scene are directly adjacent to one another.

3. The video imaging system of claim 1, wherein the respective portions of the scene overlap partially along borders between adjacent portions.

4. The video imaging system of claim 1, wherein the video imaging system stitches the portions of the scene together to form a full video image of the scene.

5. The video imaging system of claim 1, wherein the video imaging system stitches the portions of the scene together in real time to form a full video image of the scene.

6. The video imaging system of claim 1, wherein the video imaging system synchronizes the at least three cameras.

7. The video imaging system of claim 1, wherein the nodal points are coincident both laterally and longitudinally when the optical paths are unfolded.

8. The video imaging system of claim 1, wherein the beamsplitters are partially-silvered mirrors.

9. The video imaging system of claim 1, wherein the beamsplitters transmit about 50% of incident light and reflect about 50% of incident light.

10. The video imaging system of claim 1, wherein the beamsplitters are insensitive to wavelength.

11. The video imaging system of claim 1, wherein the beamsplitters are arranged at 45 degrees to incident light.

12. A video imaging system, comprising:
a housing;
at least three cameras synchronized to one another and fixedly attached to the housing;
at least two beamsplitters fixedly attached to the housing;
wherein each camera has an optical axis that extends from the camera, transmits or reflects from at least one of the beamsplitters, and extends toward a scene;
wherein the optical axes from the cameras are all angularly displaced from one another, so that the cameras can collect light from different portions of the scene;.

13. The video imaging system of claim 12, wherein at least some of the portions of the scene collected by the cameras are directly adjacent to one another.

14. The video imaging system of claim 12, wherein at least some of the portions of the scene collected by the cameras partially overlap.

15. The video imaging system of claim 12, wherein the system stitches together the collected portions of the scene to form a full image of the scene.
